(19) United States
(12) Patent Application Publication
(10) Pub. No.: US 2019/0364911 A1
(43) Pub. Date: Dec. 5, 2019

(54) METHOD FOR PRODUCING RICE FLOUR BREAD AND DOUGH THEREOF

(71) Applicants: NATIONAL AGRICULTURE AND FOOD RESEARCH ORGANIZATION, Tsukuba-shi, Ibaraki (JP); TIGER CORPORATION, Kadoma-shi, Osaka (JP)

(72) Inventors: Hiroyuki YANO, Tsukuba-shi, Ibaraki (JP); Mayako MAEDA, Kadoma-shi, Osaka (JP)

(21) Appl. No.: 16/478,649

(22) PCT Filed: Oct. 30, 2017
(86) PCT No.: PCT/JP2017/039052

§ 371 Date: Jul. 17, 2019

(30) Foreign Application Priority Data
Jan. 20, 2017 (JP) 2017-008771

(51) Int. Cl. A21D 6/00; A21D 13/047; A21D 8/04

(52) U.S. Cl. CPC A21D 6/001; A21D 8/047; A21D 13/047

(57) ABSTRACT

An object of the present invention is to provide a method of producing rice flour bread having food texture equal to or better than that of wheat flour bread or gluten-added rice flour bread without using gluten and thickener, and a method of producing dough thereof. The method of producing rice flour bread dough according to the present invention includes a cooling step, a yeast-containing basic dough preparation step and a bread dough preparation step. In the cooling step, rice flour and water are individually cooled to prepare cold rice flour and cold water. In the yeast-containing basic dough preparation step, cold rice flour and cold water are mixed to prepare basic dough, and then yeast is added to the basic dough to prepare yeast-containing basic dough, or cold rice flour, cold water and yeast are mixed to prepare yeast-containing basic dough. In the rice flour bread dough preparation step, yeast-containing basic dough is kneaded to prepare rice flour bread dough. After fermenting this rice flour bread dough to prepare fermented dough, rice flour bread according to the present invention is produced by heating the fermented dough.

### TECHNICAL FIELD

The present invention relates to a method for producing rice flour bread and its dough.

### BACKGROUND ART

In recent years, development of gluten-free rice flour bread has been promoted for the purpose of producing bread for patients with symptoms such as wheat allergy and celiac disease. As a method of producing such gluten-free rice flour bread, the method of adding thickener to bread dough is known (see, for example, JP 2005-245409 and JP 2010-193905). However, rice flour bread produced by this method is inferior to wheat flour bread and gluten-added rice flour bread in terms of food texture.

### PRIOR ART DOCUMENTS

### Patent Documents

Patent Document 1: JP 2005-245409

Patent Document 2: JP 2010-193905

### SUMMARY OF THE INVENTION

### Problem to be Solved by Invention

An object of the present invention is to provide a method for producing rice flour bread having food texture equal to or better than that of wheat flour bread or gluten-added rice flour bread without using gluten and thickener, and a method for producing dough of the rice flour bread.

### Means for Solving Problem

A method of producing rice flour bread dough according to one aspect of the present invention is a method of producing rice flour bread dough without using gluten and thickener, including a cooling step, a yeast-containing basic dough preparation step, and a rice flour bread dough preparation step. Note that although a method of producing bread requiring no gluten and thickener is disclosed by JP 2015-107081, the method of producing rice flour bread dough according to the present invention requires neither gluten nor thickener and furthermore requires neither sorghum flour nor glutathione. In the cooling step, rice flour and water are cooled to prepare cold rice flour and cold water respectively. Note that the rice flour and water may be cooled by different cooling methods, or may be cooled at different cooling locations. In the yeast-containing basic dough preparation, cold rice flour and cold water are mixed to prepare basic dough, and then yeast is added to the basic dough to prepare yeast-containing basic dough, or cold rice flour, cold water and yeast are mixed to prepare yeast-containing basic dough. Note that in an aspect of the former of this step, auxiliary material may be added to the basic dough in addition to yeast, and in an aspect of the latter, cold rice flour, cold water, yeast and auxiliary material may be mixed to prepare yeast-containing basic dough. The “auxiliary material” referred to here is, for example, salt, sugar, fat and oil or the like. In an aspect of the former of this step, the auxiliary material may be added before adding yeast, may be added simultaneously with yeast, or may be added after adding yeast. Note that in an aspect of the latter of this step, the auxiliary material may be added when cold rice flour, cold water and yeast are mixed, or may be added after mixing cold rice flour, cold water and yeast. Moreover, in this step, when the auxiliary material contains multiple types of auxiliary materials and the like, the addition timing of each auxiliary material may be simultaneous, or may differ. Moreover, when “flour-scraping-down” is to be performed, “flour-scraping-down” is preferable to be performed at this step. In the rice flour bread dough preparation step, yeast-containing basic dough is kneaded to prepare rice flour bread dough.

As a result of intensive studies by the present inventors, it has been clear that the above-described method of producing rice flour bread dough allows rice flour bread having food texture equal to or better than that of wheat flour bread or gluten-added rice flour bread to be produced without using gluten and thickener. Thus, using the above-described method of producing rice flour bread dough according to the present invention overcomes the above-described problem.

Note that in the method of producing rice flour bread dough according to one aspect of the present invention, it is preferable that the cooling step includes cooling rice flour and water individually to a temperature within a range from 5° C. to 10° C. inclusive.

Also, in the method of producing rice flour bread dough according to one aspect of the present invention, it is preferable that the rice flour bread dough preparation step includes preparing the rice flour bread dough by kneading the yeast-containing basic dough while a temperature of the yeast-containing basic dough is being adjusted.

In the method of producing rice flour bread dough according to one aspect of the present invention, it is preferable that the yeast-containing basic dough preparation step and the rice flour bread dough preparation step are performed by an apparatus including a rotor and a rotary drive source for rotating the rotor. Here, in the yeast-containing basic dough preparation step, a rotation speed of the rotor is increased stepwisely. Also, in the rice flour bread dough preparation step, after the rotor is started to rotate at a rotation speed lower than a rotation speed of the rotor at a final stage of the yeast-containing basic dough preparation step, the rotation speed of the rotor is increased stepwisely. Note that when yeast is added to basic dough after preparing basic dough in the yeast-containing basic dough preparation step, it is preferable to sufficiently lower the rotation speed of the rotor or stop rotating the rotor when yeast is added.

In the method of producing rice flour bread dough according to one aspect of the present invention, it is preferable that the rice flour has a damaged starch ratio within a range from 3% to 5% inclusive and a water absorption ratio within a range from 72% to 80% inclusive.

Using such specific rice flour allows a sufficient amount of air bubbles to be generated and maintained in the rice flour bread dough. This allows for producing rice flour bread dough having food texture equal to or better than that of wheat flour bread or gluten-added rice flour bread.

In the method of producing fermented dough according to another aspect of the present invention, rice flour bread dough obtained by the above-described method of producing rice flour bread dough is fermented to prepare fermented dough.

In the method of producing rice flour bread according to another aspect of the present invention, fermented dough obtained by the above-described method of producing fermented dough is heated to produce rice flour bread. Note that at this time, it is preferable that the fermented dough is heated to a predetermined temperature within a predetermined time to produce rice flour bread. Note that “a predetermined time” is a time for about 20 minutes, for example, and “a predetermined temperature” is a temperature about 90° C., for example. The fermented dough is preferably heated to about 60° C. within about 15 minutes. Also, heating can be performed by various heating methods using a pot, an oven, a sheathed heater, an induction heating coil (requiring a container capable of induction heating), or the like. By the way, it is particularly preferable that fermented dough is contained in a container and the fermented dough is heated by induction-heating (IH) the container. Here, the “container” is preferably made of non-magnetic metal. Induction-heating the container in this manner allows for heating the fermented dough rapidly. This allows rice flour bread to be baked to a high temperature in a short time such that air bubbles in the fermented dough can be maintained, thereby enabling rice flour bread having food texture equal to or better than that of wheat flour bread or gluten-added rice flour bread to be produced.

### BRIEF DESCRIPTION OF THE DRAWINGS

FIG. 1 is a plan view of an induction heating bread maker according to an embodiment of the present invention.

FIG. 2 is a cross-sectional view taken along the line A-A of FIG. 1.

FIG. 3 is a plan view of a bread case of the induction heating bread maker according to an embodiment of the present invention.

FIG. 4 is a cross-sectional view taken along the line B-B in FIG. 3.

FIG. 5 is a functional block diagram of an induction heating bread maker according to an embodiment of the present invention.

### REFERENCE SIGNS LIST

220 bread case (container)

### DESCRIPTION OF EMBODIMENTS

### Details of Method of Producing Rice Flour Bread According to Embodiment of Present Invention

In the method for producing rice flour bread according to an embodiment of the present invention, rice flour bread is produced through a cooling step, a yeast-containing basic dough preparation step, a rice flour bread dough preparation step, a fermentation step and a baking step. Hereinafter, the raw material of rice flour bread and each step will be described in detail. Note that in the method of producing rice flour bread according to an embodiment of the invention, a series of operation from mixing raw material to fermenting/baking may be continuously performed with a home bakery apparatus or a bread manufacturing line.

(1) Raw Material of Rice Flour Bread

Examples of the raw materials of rice flour bread include main raw material such as rice flour, water and yeast, and auxiliary materials such as salt, saccharides and fats and oils. Hereinafter, these raw materials will be described in detail. Note that in the method for producing rice flour bread according to an embodiment of the present invention, bread dough and rice flour bread are produced such that gluten and thickener are not contained in the bread dough. Thus, the method or the like that excludes gluten and thickener from bread dough and/or rice flour bread will be also described in detail below.

(1-1) Rice Flour

“Rice flour” is powder obtained by grinding seeds (raw rice) of Oryza sativa. Although rice used as the raw material of this rice flour should not be specifically limited, it is preferably non-glutinous rice. Examples of non-glutinous rice include Japonica rice, Indica rice, Javanica rice, or the like. In addition, various varieties of rice belonging to these may be used. The variety of rice should not be particularly limited; for example, examples thereof include varieties suitable for rice for rice flour, such as “Takanari”, “Mizuhochikara”, and “Yumefuwari”. In addition, it may be rice of any variety of varieties having high amylose content, varieties having medium amylose content and varieties having low amylose content. The rice flour may also be a mixture of various varieties of rice flour. Note that the rice flour used herein does not need to contain pregelatinized rice flour obtained by drying and pulverizing after pregelatinizing (gelatinizing) rice by heating.

In addition, it is preferable that the rice flour used herein has a damaged starch ratio within a range from 3% to 5% inclusive and a water absorption ratio within a range from 72% to 80% inclusive; it is more preferable that the rice flour used herein has a damaged starch ratio within a range from 4% to 5% inclusive and a water absorption ratio within a range from 74% to 80% inclusive.

The damaged starch ratio of rice flour can be measured by a usual method. The damaged starch ratio of rice flour according to an embodiment of the present invention can be measured using a damaged starch measurement kit Starch Damage Assay Kit (Megazyme) or a kit or reagent equivalent thereto. More specifically, first, 100 mg of rice flour and amylase solution (50 U/mL) are pre-incubated at 40° C. for about 5 minutes in separate containers. Next, 1 mL of amylase solution is added to the rice flour, and they are mixed by a vortex mixer and then are subjected to a decomposition reaction at 40° C. for 10 minutes to obtain a primary enzyme decomposition solution of rice flour. Next, 8 mL of sulfuric acid solution (0.2% v/v) is added to the primary enzyme decomposition solution, and they are mixed with a vortex mixer to terminate the decomposition reaction. Subsequently, the primary enzyme decomposition solution after terminating the decomposition reaction is centrifuged at 3,000 rpm for 5 minutes. 0.1 mL of the supernatant of the enzyme decomposition solution after centrifugation is collected, and 0.1 mL of an amyloglucosidase solution is added to the supernatant and then is subjected to a decomposition reaction at 40° C. for 10 minutes to obtain a secondary enzyme decomposition solution. A solution of 4 mL of glucose measurement reagent GOPOD (glucose oxidase and peroxidase) is added to the secondary enzyme decomposition solution, and then is reacted at 40° C. for 20 minutes to obtain a reaction solution. The absorbance of the reaction solution at a wavelength of 510 nm is then measured. After a GOPOD solution is added to 150 mg/mL of glucose standard solution and buffer solution (blank) and then is reacted, the absorbance is measured in the same manner as the above reaction solution to prepare a calibration curve. In an embodiment of the present invention, the damaged starch ratio (%) of rice flour is calculated based on this calibration curve.

Moreover, the water absorption ratio of rice flour can be measured by a usual method. The water absorption ratio of rice flour according to an embodiment of the present invention can be measured as follows. First, after 10 g of rice flour (in a dry state) is placed in a 50 mL processing tube, ion-exchanged water is added up to the scale of 50 mL to prepare a sample solution. Next, after the sample solution is left to stand at room temperature overnight, the sample solution is centrifuged at 3000 rpm for 30 minutes. The supernatant is discarded from the sample solution after centrifugation, and the weight of rice flour at that time (weight of rice flour after water absorption; that is, the total weight of rice flour and water absorbed by rice flour) is measured. Subsequently, the water absorption ratio of rice flour can be calculated by substituting the measured value into the following equation.

Water absorption ratio (%)=(rice flour weight after water absorption−rice flour weight before water absorption (10 g))/rice flour weight before water absorption (10 g)×100

The rice flour used in an embodiment of the present invention may preferably have a most frequent particle diameter of 2,000 μm or less, and may more preferably have a most frequent particle diameter within a range from 70 μm to 130 μm inclusive. Using such rice flour makes it possible to produce fine-grained bread. Note that, the most frequent particle diameter of rice flour can be calculated by measuring the particle size distribution in a dry manner in accordance with a manual with a particle size distribution measuring apparatus (LS13320 [Beckman Coulter] or an apparatus equivalent thereto).

The above-described rice flour used in the present invention should not be limited to the above; it is preferable that rice flour is produced by a wet air-pulverization method. In addition, the above-described rice flour can also be obtained as a commercial product.

(1-2) Water

Water should not be particularly limited as long as it is drinkable water. The amount of water in the bread dough may be a common amount of water used as a raw material in producing bread using rice flour, and is preferably an amount within a range from 70% by weight to 120% by weight inclusive of the amount of rice flour. Water in the bread dough may be added as water, or may be added as one component of another raw material. For example, the water in the bread dough may be water derived from milk, soy milk, beverages such as juice, and the like that are added to the bread dough.

(1-3) Yeast

The yeast blended into the bread dough may be any yeast that can be used for fermentation of bread, and is typically baker's yeast (Saccharomyces cerevisiae strain used for producing bread). The yeast used in the method for producing rice flour bread according to an embodiment of the present invention is yeast that does not secrete gluten-constituting proteins. The yeast may be dried yeast or may be live yeast. Moreover, yeast may be contained in so-called fermented species (starter). The fermented species is a fermented product obtained by fermenting and growing yeast existing in nature, and may contain various microorganisms such as lactic acid bacteria in addition to baker's yeast. Such fermented species may be blended into bread dough as a source of yeast. However, in order to prepare gluten-free and thickener-free bread dough, using gluten-free and thickener-free ingredients is required in preparation. Those skilled in the art can appropriately adjust the blending amount of yeast suitable for producing bread; in general, the blending amount of yeast within a range from 0.5% by weight to 5% by weight inclusive of the amount of rice flour by dry weight may be used.

(1-4) Salt

In an embodiment of the present invention, “salt” refers to food grade or pharmaceutical grade salt (salt having sodium chloride as a main component). In addition to sodium chloride as the main component, salt may contain, for example, other inorganic salts such as potassium chloride, calcium chloride, magnesium chloride and the like. Any salt product can be used as salt to be blended into the dough according to the present invention. For example, high purity salt such as commercially available purified salt (salt containing almost only sodium chloride), unpurified salts (salt containing sodium chloride as a main component but containing a larger amount of other inorganic salt) and the like can be used. When purified salt (salt containing sodium chloride in a percentage of 99% or more by dry weight) is added to bread dough, the amount of purified salt is approximately equal to its sodium chloride content, and thus the salt content in bread dough can be calculated based on the addition amount of the purified salt. In contrast, when unrefined salt (salt containing sodium chloride in a percentage of less than 99% by dry weight) are added to bread dough, the salt content in bread dough is calculated based on an amount equivalent to sodium chloride calculated from the sodium content of the added unrefined salt. Note that the amount equivalent to sodium chloride is calculated by multiplying the sodium content by 2.54.

(1-5) Saccharides

In an embodiment of the present invention, as saccharides, any saccharides (however, except polysaccharides), such as sugar, glucose, fructose, honey, maltose, brown sugar, granulated sugar, and the like can be used. As sugar, any sugar, such as white sugar, brown sugar, millet sugar, sucrose and the like, can be used, for example.

(1-6) Fats and Oils

In an embodiment of the present invention, examples of fats and oils include vegetable fats and oils such as olive oil or canola oil, animal fats and oils such as butter, any fats and oils such as margarine or shortenings, or mixtures thereof; preferable examples thereof include butter and canola oil.

(1-7) Other Auxiliary Materials

In an embodiment of the present invention, foods such as meat/fish, nuts, mushrooms, fruits, vegetables, herbs, beans, beverages, dairy products, fermented foods, sweeteners, sweets, spices and the like, or food ingredients, such as eggs, ham, sausage, bacon, almond, carrot, sesame, raisin, apples, green soybeans, vegetable juice, rosemary, milk, cheese, yogurt, trehalose, chocolate, cinnamon powder, and the like may be kneaded into bread dough. In addition, food additives such as emulsifiers, preservatives, flavors and colorants may be kneaded into bread dough as long as the bread dough according to an embodiment of the present invention does not contain gluten and thickener.

(1-8) Methods for Excluding Gluten and Thickener from Bread Dough and/or Rice Flour Bread

As described above, in the method for producing rice flour bread according to an embodiment of the present invention, bread dough and rice flour bread are produced such that gluten and thickener are not contained in the bread dough. To produce bread dough such that bread dough does not contain gluten, it is easiest to avoid mixing gluten, gluten-constituting protein, or cereal flour containing gluten-constituting protein (wheat flour, rye flour, barley flour, oat flour, cereal flour of those hybrids, or the like) into bread dough. In the method for producing rice flour bread according to an embodiment of the present invention, it is preferable to use only rice flour as cereal flour; it is particularly preferable to use only rice flour having a damaged starch ratio within a range from 3% to 5% inclusive and a water absorption ratio within a range from 72% to 80% inclusive.

Here, “bread dough does not contain the above-described gluten component” means that an effective amount of these ingredients are not present in bread dough. If gluten, gluten-constituting proteins or other cereal flours are not used as raw material for dough, but very small amount thereof are mixed into bread dough or in a bread producing process, an effective amount of gluten, gluten-constituting proteins or other cereal flours is not present in the bread dough. Thus, it should be recognized that the bread dough does not contain gluten, gluten-constituting proteins or other cereal flours. More specifically, when a mixed amount of gluten in bread dough is less than 0.5% by weight (preferably less than 0.1% by weight) of an amount of rice flour, an effective amount of gluten is not present in the bread dough. Such bread dough according to an embodiment of the present invention is considered to contain no gluten. Also, when a mixed amount of gluten-constituting protein or other cereal flour in bread dough is less than 1.0% by weight (preferably less than 0.1% by weight) of an amount of rice flour, an effective amount of gluten-constituting protein or other cereal flour is not present in the bread dough. Such bread dough according to an embodiment of the present invention is considered to contain neither gluten-constituting protein nor other cereal flour.

In the method for producing rice flour bread according to an embodiment of the present invention, it is preferable that bread dough is “gluten free” more strictly. “Gluten” also includes gluten-like proteins derived from other cereal flour as well as wheat gluten derived from wheat flour. Gluten is produced by a reaction of gluten-constituting proteins (gliadin and glutenin in the case of wheat flour) contained in cereal flour in the presence of water. The gluten-constituting protein corresponding to wheat gliadin is called hordein in barley, secalin in rye, and apenine in oats. In an embodiment of the present invention, “gluten free” means that the gluten content is 0.002% or less (20 mg/kg or less) of the total weight (total mass) of the food. This is a value that is set as a “gluten free” standard by the Codex committee in 2008. Typically, producing bread dough and the like according to an embodiment of the present invention using a manufacturing line exclusively for gluten-free products prevents wheat flour, gluten, and the like from mixing and allows for producing gluten-free bread dough.

Moreover, although thickener is usually used in producing gluten-free rice flour bread, bread dough according to an embodiment of the present invention does not contain not only gluten but also thickener. Examples of thickeners include a wide variety of thickeners that can be used in the food field, such as thickening polysaccharides, gelling agents, and the like. Examples of thickeners include alginic acid, gum arabic, carrageenan, carboxymethylcellulose, guar gum, xanthan gum, locust bean gum, pectin, cellulose, tamarind seed gum, psyllium seed gum, gluconmannan, gelatin, agar, soy polysaccharide, tapioca starch, corn starch, arrowroot starch, dogtooth violet starch, potato starch and derivatives thereof (acetylated products, esterified products, degradation products and the like); however, examples should not be limited to the above. Note that even if a component having a thickening property is produced from rice flour, yeast or other raw materials during bread dough production or rice flour bread production in the method for producing rice flour bread according to an embodiment of the present invention, such a component shall not be included in the “thickener”. Here, “bread dough according to an embodiment of the present invention does not contain thickener” means that no effective amount of thickener is present in bread dough. If thickener is not used as raw material for dough, but very small amount thereof is mixed in a bread dough producing process or in a bread producing process, an effective amount of thickener is not present in the bread dough. Thus, such bread dough according to an embodiment of the present invention is recognized to contain no thickener. More specifically, when a mixed amount of thickener in bread dough is less than 0.05% by weight (preferably less than 0.005% by weight) of an amount of rice flour, the effective amount of thickener is not present in the bread dough. Such bread dough according to an embodiment of the present invention is considered to contain no thickener.

Note that in the present invention, the above-described standard with which it is determined that gluten, gluten-constituting protein, cereal flour other than rice flour or thickener is not contained is applied not only to bread dough but also to basic dough and rice flour bread in the same manner.

(2) Details of Each Step

(2-1) Cooling Step

In a cooling step, rice flour and water are each cooled. Note that although this cooling step is normally performed by putting rice flour and water in a refrigerator whose temperature is set to a temperature within a range from 5° C. to 10° C. inclusive, other cooling processes may be used to cool rice flour and water.

(2-2) Yeast-Containing Basic Dough Preparation Step

In a yeast-containing basic dough preparation step, (i) after cooled rice flour (hereinafter referred to as “cold rice flour”) and cooled water (hereinafter referred to as “cold water”), both of which are cooled in a cooling step, are mixed to prepare basic dough, yeast is added to the basic dough to prepare yeast-containing basic dough, or (ii) cold rice flour, cold water and yeast are mixed to prepare yeast-containing basic dough. As described above, in an aspect of (i) of the present step, auxiliary material may be mixed with the basic dough as needed as long as the state of the basic material is not significantly changed; it is preferable to prepare the basic dough from only cold rice flour and cold water. This is because the dough can be kept relatively hard in the first half of the preparation of the basic dough, and bubbles can be more efficiently contained in the basic dough. Note that the yeast may be pre-fermented or may be used without pre-fermentation. In addition, here, auxiliary material (other than gluten and thickener) may be used with yeast.

Note that preparation of the basic dough in an aspect of (i) of the present step may be performed by mixing cold rice flour and cold water manually, or alternatively it may be performed by using an apparatus with stirring/heating functions, such as a home bakery apparatus, or a stirring apparatus. Moreover, an aspect of (ii) of the present step may be performed by mixing cold rice flour, cold water, yeast, and the like manually, or alternatively it may be performed by using an apparatus with stirring/heating functions, such as a home bakery apparatus, or a stirring apparatus. Moreover, when an apparatus with stirring/heating functions or a stirring apparatus is used, it is preferable to set the stirring speed so that the stirring speed becomes faster stepwisely. Note that when an apparatus with stirring/heating functions, such as a home bakery apparatus, or a stirring apparatus is used in an aspect of (i) of the present step, it is preferable to lower the stirring speed of the apparatus or temporarily stop stirring when yeast is added. Furthermore, when “flour-scraping-down” is performed in this step, it is preferable to temporarily stop stirring.

(2-3) Rice Flour Bread Dough Preparation Step

In the rice flour bread dough preparation step, the yeast-containing basic dough prepared in the yeast-containing basic dough preparation step, which is the preceding step, is sufficiently kneaded to prepare rice flour bread dough. Note that in this rice flour bread dough preparation step, it is preferable to adjust temperature such that the rice flour bread dough has a temperature higher than room temperature (e.g., about 30° C. to 35° C.) in the second half of the step. Adjusting the temperature in this manner allows a fermentation time in the fermentation step to be constant, thereby making it possible to bake the rice flour bread stably.

This step may be performed manually, or may be performed using an apparatus with stirring/heating functions, such as a home bakery apparatus, or a stirring apparatus. In addition, when an apparatus with stirring/heating functions or a stirring apparatus is used, it is preferable to set the stirring speed so that the stirring speed becomes faster stepwisely; it is preferable that a speed in an initial stage is set to a speed slower than a speed in a final stage of the yeast-containing basic dough preparation step.

(2-4) Fermentation Step

In a fermentation step, the rice flour bread dough prepared in the rice flour bread dough preparation step is fermented to prepare fermented dough. For example, fermentation of the rice flour dough can be performed by any method used for producing bread after the rice flour dough is placed in a container, divided or shaped. For example, rice flour bread dough can be fermented by leaving to stand rice flour bread dough under a temperature suitable for fermentation (4° C. to 50° C., typically 25° C. to 450°) for about 20 minutes to 4 hours (more typically about 25 minutes to 2 hours). Note that in this fermentation step, fermentation may be performed only once, and may be performed twice or more. For example, primary fermentation (also called floor time) in which rice flour bread dough is fermented by leaving to stand rice flour bread dough at a relatively low temperature (for example, 15° C. to 32° C.) for about 5 minutes to 2 hours (more typically, about 5 minutes to 60 minutes) may be performed. At a stage where the fermentation has proceeded to some extent by the primary fermentation, rice flour bread dough may be furthermore fermented at a temperature within a range from 4° C. to 45° C. (more preferably 25° C. to 42° C.) for typically 15 minutes to 2 hours (more typically 30 minutes to 90 minutes)(final fermentation called a temperature controlled chamber). Alternatively, rice flour bread dough may be fermented without interruption until completion of the final fermentation by putting the rice flour bread dough into a container (mold) for rice flour bread molding and fermenting it.

Note that this step allows rice flour bread dough to swell significantly. More specifically, at the end of the fermentation, the specific volume of the rice flour bread dough can be 3 mL/g or more, and sometimes 4 mL/g or more. In the method for producing rice flour bread according to an embodiment of the present invention, it is preferable to ferment rice flour bread dough to a specific volume of 3 mL/g or more, particularly 4 mL/g or more. Here, the specific volume of the rice flour bread dough can be calculated by dividing a volume (mL) of the fermented rice flour bread dough by a weight of the rice flour bread dough.

Also, the rice flour bread dough may be packaged, in any manner, in a sealed container or bag, for example. Also, here, the rice flour bread dough may be subjected to processing such as sterilization, refrigeration, freezing and the like.

The method for producing rice flour bread according to an embodiment of the present invention may include, if necessary, one or more arbitrary steps of a dividing step, a forming step, a packaging step, a sterilization step, a refrigeration or freezing step, and the like during a period from the completion of the fermentation step to before the baking step.

(2-5) Baking Step

In the baking step, fermented dough is heated to a predetermined temperature within a predetermined time to obtain a target rice flour bread. Note that baking of fermented dough can be performed by a usual method using various heating devices such as a pot, an oven, a sheathed heater, and an induction heating coil (requiring a container capable of induction heating). More specifically, this step may be performed by heating (for example, heating at 100° C. to 240° C.) the fermented dough by any means such as an oven, a microwave oven, a pot, a home bakery and the like. The baking time is typically about 5 minutes to 100 minutes. The baking temperature and the baking time can be appropriately adjusted by those skilled in the art. As described above, the rice flour bread dough obtained by the method for producing rice flour bread according to an embodiment of the present invention exhibits good swelling even after baking. The rice flour bread obtained here is preferable to have a specific volume after baking of 3 mL/g or more, particularly preferable 4 mL/g or more. Here, the specific volume of bread (hereinafter referred to as “specific bread volume”) can be calculated by dividing a volume (mL) of baked bread by a weight of the bread. Note that nuts, fruits, creams, syrups and the like may be further topped on baked bread, and a side dish, ham and the like may be sandwiched to produce a sweet bun, cooked bread or the like. The rice flour bread thus processed is also included in the scope of the rice flour bread according to the present invention. The rice flour bread according to the present invention may take any form such as bread, a roll, round bread, side dish bread, a sweet bun or the like.

### Details of Bread Maker Suitable for a Method of Producing Rice Flour Bread According to an Embodiment of the Invention

For implementation of a method for producing rice flour bread according to an embodiment of the present invention, an induction heating bread maker described below is most suitable. The induction heating bread maker will be described in detail below. Note that it should be understood that this induction heating bread maker is merely an example; it should not be construed that it is impossible to perform the method of manufacturing rice flour bread according to an embodiment of the present invention without this induction heating bread maker.

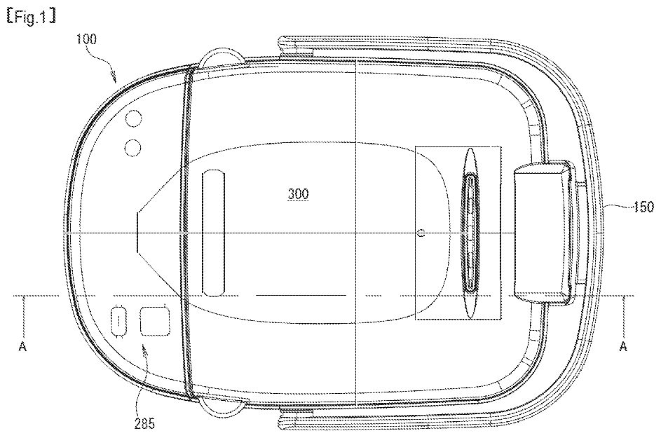

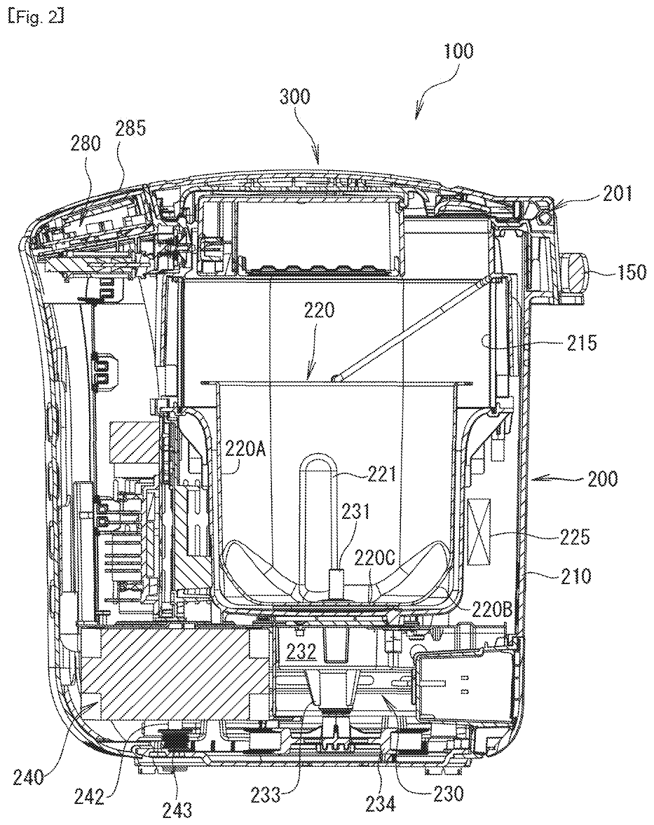

The induction heating bread maker 100 mainly includes a main body 200 and a lid 300, as shown in FIGS. 1 and 2. Hereinafter, the main body 200 and the lid 300 will be each described in detail.

1. Main Body

As shown in FIGS. 1 and 2, the main body 200 mainly includes an outer body 210, a baking chamber 215, a bread case 220, an induction heating coil 225, a stirrer 230, a stirring motor 240, and a baking chamber temperature sensor (not shown), a control board 280, an operation panel 285 and a buzzer alarm 466. Hereinafter, these components will be described in detail.

(1) Outer Body

As shown in FIG. 2, the outer body 210 is a resin molded product having a substantially cylindrical shape with a bottom. Also, the outer body 210 is provided with a movable handle 150 for easily carrying.

(2) Baking Chamber

As shown in FIG. 2, the baking chamber 215 houses the bread case 220 detachably, and the induction heating coil 225 and the baking chamber temperature sensor are fixedly arranged.

(3) Bread Case

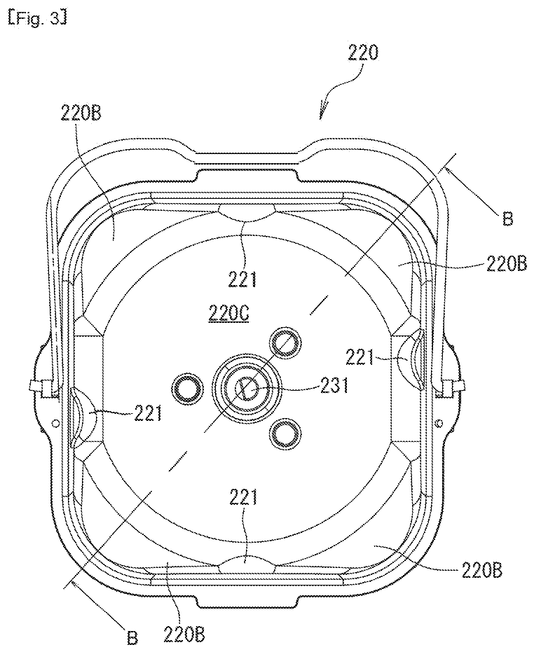

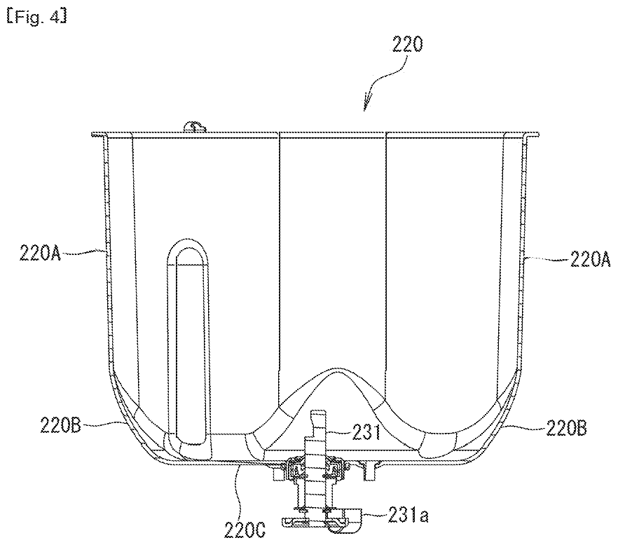

The bread case 220 is a substantially rectangular cylindrical metal member formed of stainless steel or a clad material (a composite material of stainless steel, aluminum, and copper); as shown in FIGS. 2 to 4, the bread case 220 is formed mainly with a bottom wall portion 220C, an intermediate wall portion 220B, a side wall portion 220A and a rib 221. The bottom wall portion 220C is a substantially square flat plate shaped portion. As shown in FIG. 2, a stirring blade mounting shaft 231 is rotatably mounted at the center of the bottom wall portion 220C. A stirring blade (not shown) is detachably mounted on the stirring blade mounting shaft 231. Further, at the lower end of the stirring blade mounting shaft 231, a connection portion 231a is provided as shown in FIG. 4. And this connection portion 231a is connectable to the coupling member 232 (described later). In other words, the stirring blade mounting shaft 231 can be connected to the rotating shaft 233 (described later) via the connection portion 231a and the coupling member 232. The intermediate wall portion 220B is a portion having a substantially rectangle-like shape (like a shape obtained by cutting the bottom of a square bowl) extending from the outer edge of the bottom wall portion 220C. In other words, when the bottom wall portion 220C and the intermediate wall portion 220B are combined, the shape becomes a substantially rectangle-like shape. The side wall portion 220A is a substantially rectangular cylindrical portion extending from the upper end of the intermediate wall portion 220B. In other words, the intermediate wall portion 220B and the side wall portion 220A are different in shape and size. However, the shape of the side wall portion 220A is similar (has similarity in geometry) to the shape of the induction heating coil 225. As shown in FIGS. 2 to 4, the ribs 221 are formed to project toward the stirring blade mounting shaft 231 in a region from the upper end to the lower end of the substantially flat portion in the width direction of each plate portion of the side wall portion 220A. The bread case 220 is detachably housed in the baking chamber 215 as described above.

(4) Induction Heating Coil

The induction heating coil 225 is a bobbin-type induction heating coil, and is disposed under the baking chamber 215 as shown in FIG. 2. The induction heating coil 225 surrounds the periphery of the lower end portion of the side wall portion 220A of the bread case 220 in a state where the bread case 220 is normally installed in the baking chamber 215. In other words, in the normal installation state of bread case 220, the lower end position of the induction heating coil 225 substantially coincides with the upper end position of the intermediate wall portion 220B. The induction heating coil 225 is connected to the control board 280, and is controlled by the control board 280 when the temperature of rice flour bread dough is controlled, bread is baked, the presence or absence of the bread case is confirmed, and the like.

(5) Stirrer

As shown in FIG. 1, the stirrer 230 mainly includes a stirring blade, a coupling member 232, a rotating shaft 233 and a pulley 234. The stirring blade is detachably attached to the stirring blade mounting shaft 231 as described above.

The coupling member 232 is provided for detachably connecting the stirring blade mounting shaft 231 and the rotating shaft 233 as described above. As shown in FIG. 2, the rotating shaft 233 is rotatably supported at the bottom of the outer body 210. Further, a pulley 234 is attached to the lower end of the rotating shaft 233.

(6) Stirring Motor

The stirring motor 240 is a commonly used electric motor, and is disposed at the bottom of outer body 210 beside the rotating shaft 233. The stirring motor 240 is installed such that the rotating shaft 242 extends downward. Further, a pulley 243 is attached to the tip end portion of the rotating shaft 242, that is, the lower end portion of the rotating shaft 242. A belt (not shown) is installed over the pulley 243 and the pulley 234 of the stirrer 230. Thus, driving the stirring motor 240 causes the rotational driving force to be transmitted to the rotating shaft 233 via the pulley 243, the belt and the pulley 234. When the rotational driving force of the stirring motor 240 is transmitted to the rotating shaft 233, the stirring blade rotates via the coupling member 232.

(7) Baking Chamber Temperature Sensor

The baking chamber temperature sensor is disposed substantially at the center of the baking chamber 215. When the bread case 220 is housed in the baking chamber 215, the baking chamber temperature sensor faces the vicinity of the upper portion of the bread case 220 with a predetermined gap therebetween. Further, the baking chamber temperature sensor is communicably connected to the control board 280.

The baking chamber temperature sensor then measures a temperature in the vicinity of the bread case 220, and periodically transmits the measurement signal to the control board 280.

(8) Control Board

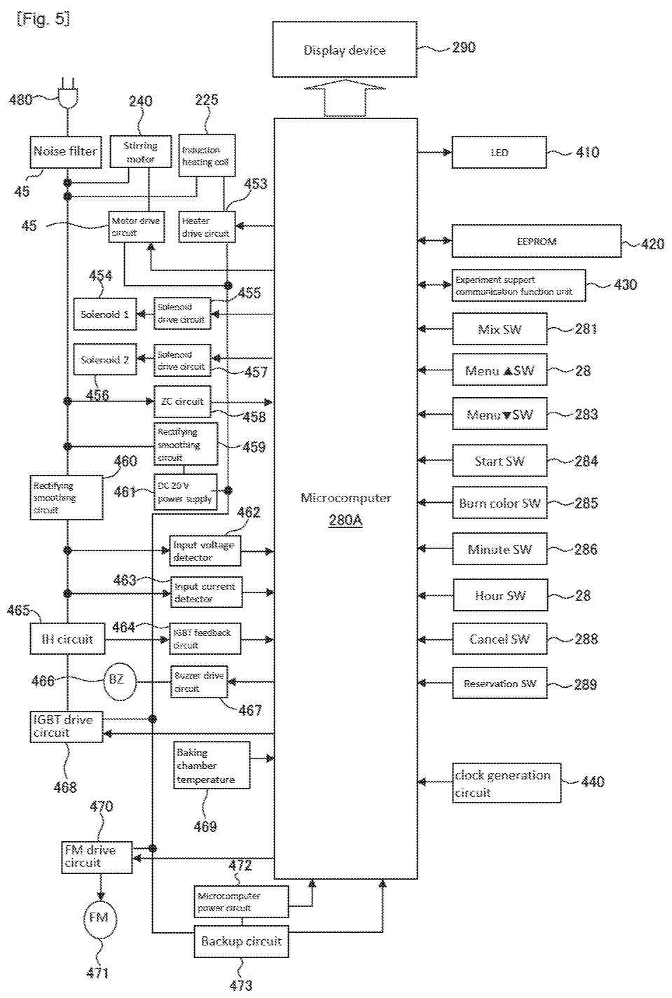

The control board 280 is an electronic circuit board including a microcomputer 280A (see FIG. 5), a timer (not shown), an LED 410, an EEPROM 420, a display device 290 (see FIG. 5), an experiment support communication function unit 430, and various circuits 440, 452, 453, 455, 457, 458 to 460, 464, 465, 467, 468, 470, 472 and 473, an input voltage detector 462, an input power detector 463 and various input buttons 281 to 289 (see FIG. 5). As shown in FIG. 2, the control board 280 is disposed on the upper front side. As shown in FIG. 5, the control board 280 is communicably connected to the induction heating coil 225, the stirring motor 240, the baking room temperature sensor 469, the LED 410, the solenoids 454 and 456, the FM 471 (see FIG. 5) and the like. In each step for producing bread, the control board 280 appropriately controls the induction heating coils 225 and the stirring motor 240 based on input signals from various input buttons 281 to 289, signals inputted from the baking chamber temperature sensor 469, the timer or the like, control programs introduced to the microcomputer 280A, or the like. Note that the aspect of this control is described later.

(9) Operation Panel

The operation panel 285 is provided above the control board 280. Various input buttons 281 to 289 and the display device 290 are arranged on the operation panel 285. Note that as shown in FIG. 5, the various input buttons 281 to 298 and the display device 290 are connected to the microcomputer 280A.

(10) Buzzer Alarm

The buzzer alarm 466 (see FIG. 5) is for notifying a user by a buzzer sound, and outputs a buzzer sound based on a command from the microcomputer 280A.

2. Lid

The lid 300 is openably connected to the main body 200 via a hinge mechanism 201. As shown in FIG. 1, the lid 300 is a shallow, bowl-shaped resin molded product, and covers the upper portion of the baking chamber 215 of the main body 200.

<Operation of Induction Heating Bread Maker>

In the induction heating bread maker 100, when gluten/thickener-free rice flour bread is produced, the rice flour bread is produced through a first kneading step, a rest step, a second kneading step, a fermentation step and a baking step. Note that in this induction heating bread maker 100, the time management of each step is performed by a timer and a microcomputer 280A, and the next step is started after a predetermined time from the start of each step. Hereinafter, the operation of the induction heating baking apparatus 100 at the time of preparation of rice flour bread will be described.

When a user inserts main ingredients such as cold rice flour, cold water and the like into the bread case 220 and presses an operation start input button, the first kneading step is started.

In the first kneading step, the stirrer 230 is normally operated by the control board 280, and the main raw material are mixed (kneaded) for a certain time with the stirring blade to prepare rice flour bread dough. At this time, the stirrer 230 is controlled by the control board 280 so that the stirring speed of the stirrer 230 is increased stepwisely.

In the rest step, the stirrer 230 is stopped by the control board 280. At this time, flour-scraping-down, addition of yeast and/or auxiliary materials, etc. are performed manually.

In the second kneading step, in the same manner as in the first kneading step, the stirrer 230 is normally operated by the control board 280, and the rice flour bread dough is kneaded for a certain time with the stirring blade. Note that in the second half of this second kneading step, the control board 280 controls the output of the induction heating coil 225 based on the measurement signal from the baking chamber temperature sensor to maintain the temperature in the baking chamber 215 at about 30° C.

In the fermentation step, the stirrer 230 is stopped by the control board 280, and the output of the induction heating coil 225 is controlled based on the measurement signal from the baking chamber temperature sensor to maintain the temperature in the baking chamber 215 at a temperature within a range from about 30° C. to 35° C. Note that the degassing operation may be performed during the fermentation step. A specific example of the degassing operation includes shutting off the energization to the induction heating coil 225 (stopping heating by the induction heating coil 225) by the control board 280 and operating the stirrer 230 at low speed. Note that it is sufficient to perform this degassing operation for a short time (tens of seconds).

In the baking step, the stirrer 230 is stopped by the control board 280, and the output of the induction heating coil 225 is controlled based on the measurement signal from the baking chamber temperature sensor to maintain the temperature in the baking chamber 215 at about 130° C. As a result, the desired rice flour bread is produced.

### Features of the Method for Producing Rice Flour Bread According to an Embodiment of the Present Invention

The method for producing rice flour bread according to an embodiment of the present invention allows rice flour bread having food texture equal to or better than that of wheat flour bread or gluten-added rice flour bread to be produced without using gluten and thickener. Thus, the method for producing rice flour bread can provide rice flour bread that can be ingested by people, such as wheat allergy patients and celiac disease patients, who should avoid gluten intake.

Note that in the method for producing rice flour bread according to the present invention, when rice flour bread dough (fermented dough) from rice flour having a damaged starch ratio within a range from 3% to 5% inclusive and a water absorption ratio within a range from 72% to 80% inclusive is prepared, and the rice flour bread dough (fermented dough) in the bread case is baked by induction heating (IH), rice flour bread in a state in which air bubbles are uniformly dispersed can be produced.

<Modification>

(A)

Although it is not particularly mentioned in the method for producing rice flour bread according to the previous embodiments, “flour-scraping-down” may be performed, in an aspect of (i) of the yeast-containing basic dough preparation step, during a period from after preparing basic dough to before adding yeast, or at the time of adding yeast and the like.

(B)

In the method for producing rice flour bread according to the previous embodiments, it was stated that auxiliary materials (except for gluten and thickener) may be added together with yeast in the yeast-containing basic dough preparation step; a step for adding auxiliary material may be provided separately from the yeast-containing basic dough preparation step. Note that this step for adding auxiliary material is preferable to be performed during a period from after the yeast-containing basic dough preparation step to before the fermentation step.

### Example

Hereinafter, the present invention will be more specifically described using examples. Note that the technical scope of the present invention should not be limited to these examples.

### Example 1

1. Raw Material

Rice flour, water, sugar, salt, canola oil and dry yeast were prepared as raw material for producing rice flour bread. Note that “Riz Farine (damaged starch ratio: 4.7%, water absorption ratio: 76% and most frequent particle diameter: 116 μm)” manufactured by Gunma Flour Milling Co., Ltd. was used as rice flour: “white superior soft sugar” manufactured by Pearl Ace Co., Ltd. was used as sugar; “Setouchi no Shio” manufactured by Aeon Co., Ltd. was used as salt; “Nisshin Canola Oil”” manufactured by Nisshin Oillio Group, Inc. was used as canola oil; “Super Camellia dry yeast” manufactured by Nisshin Foods Co., Ltd. was used as dry yeast. Note that the raw material does not contain any cereal flour containing gluten-constituting proteins such as wheat flour, gluten-constituting proteins, gluten and thickener.

2. Production of Rice Flour Bread

First, rice flour and water among the above-described raw materials were placed in a refrigerator for half a day or more and cooled to a temperature within a range from about 3° C. to 10° C. to prepare cold rice flour and cold water. Next, 250 g of cold rice flour and 220 g of cold water were placed in the bread case of a prototype of IH Home Bakery manufactured by Tiger Co., Ltd. (IH Home Bakery KBX-A100 manufactured by Tiger Co., Ltd. with the addition of the following ““gluten free bread without additives” menu”; the apparatus structure is the same as the structure of the induction heating bread maker described in the above embodiment.), and then the bread case was mounted to the IH home bakery. Next, the “gluten free bread without additives” menu was selected in the IH home bakery to start driving the IH home bakery. After opening the lid of the IH home bakery when an alarm for notifying a manual operation from the IH home bakery sounds, and then scraping down the flour attached on the bread case wall using the rubber spatula, 6 g of dry yeast, 3 g of canola oil, 24 g of sugar and 4 g of salt were added in the bread case. Subsequently, after closing the lid of the IH home bakery, the IH home bakery was operated again to obtain the desired rice flour bread.

Note that the outline of the sequence of the “gluten free bread without additives” menu of the IH home bakery is as described in Table 1 below.

TABLE 1

| | | | | Flour scraping | | | | | | | |
|---|---|---|---|---|---|---|---|---|---|---|---|
| | Kneading | Kneading | Kneading | down/Auxiliary | Kneading | Kneading | Fermen- | | Fermen- | | |
| | 1 | 2 | 3 | material insert | 4 | 5 | tation 1 | Degassing | tation 2 | Baking | Unit |
| Induction | OFF | OFF | OFF | OFF | OFF | ON | ON | OFF | ON | ON | |
| heating | | | | | | | | | | | |
| Temperature | | | | | | 30 | 30 | | 35 | 130 | ° C. |
| of bread case | | | | | | | | | | | |
| Rotation speed | Low | Medium | High | Stop | Medium | High | Stop | Low | Stop | Stop | |
| of a motor | | | | | | | | | | | |
| Method for | Inter- | Inter- | Inter- | | Inter- | Inter- | | Continuous | | | |
| driving a motor | mittent | mittent | mittent | | mittent | mittent | | | | | |
| Timer | 60 | 60 | 1140 | 300 | 60 | 1080 | 300 | 20 | 2320 | 1860 | Second |

This sequence causes the first kneading step, the second kneading step, the third kneading step, the flour-scraping-down/auxiliary material insert step, the fourth kneading step, the fifth kneading step, the first fermentation step, the degassing step, the second fermentation step, and the baking step to be performed automatically and continuously. Note that as apparent from Table 1, the kneading operation is temporarily stopped and an alarm for notifying a manual operation (a sound of “pip pip”) sounds 21 minutes after starting operation. At that time, it is necessary to open the lid of the IH home bakery and manually “remove powder”. Note that after the powder is removed, the auxiliary material may be added if necessary. When the “flour-scraping-down” is completed, the lid is closed; after that, pressing the operation button again causes the subsequent steps after the “fourth kneading step (kneading 4)” to be automatically performed.

As described in Table 1, the first kneading step is performed for 60 seconds. In this step, induction heating is not performed, and the motor for driving the stirring blade is intermittently rotated at low speed. The second kneading step is performed for 60 seconds. In this step, induction heating is not performed, and the motor rotates intermittently at medium, speed. The third kneading step is performed for 1140 seconds. In this step, induction heating is not performed, and the motor intermittently rotates at high speed. The flour-scraping-down and auxiliary material adding step is performed within 300 seconds. In this step, induction heating is not performed and the motor is stopped. The fourth kneading step is performed for 60 seconds. In this step, induction heating is not performed, and the motor rotates intermittently at medium speed. The fifth kneading step is performed for 1080 seconds. In this step, the motor is intermittently rotated at high speed, and the bread case is induction-heated so that the temperature of the bread case becomes 30° C. The first fermentation step is performed for 300 seconds. In this step, the motor is stopped and the bread case is induction-heated so that the temperature of the bread case becomes 30° C. The degassing step is performed for 20 seconds. In this step, induction heating is not performed, and the motor rotates continuously at low speed. The second fermentation step is performed for 2320 seconds. In this step, the motor is stopped, and the bread case is induction-heated so that the temperature of the bread case becomes 35° C. The baking step is performed for 1860 seconds. In this step, the motor is stopped and the bread case is induction-heated so that the temperature of the bread case becomes 130° C.

On the next day of the day on which baking was performed, the obtained rice flour bread was subjected to weight measurement and shape measurement with a laser volumeter (SELNAC-WinVM2100A, Astex Co., Ltd.) to obtain a measured value of specific volume (mL/g) that is an index of the expansivity of bread. The specific volume is expressed as a volume of bread per one gram of bread (mL/g). The specific volume of this rice flour bread was 4.2 mL/g.

In rice flour bread dough using wheat flour and gluten as raw material, confining fermented gas into the network of sticky gluten protein causes bread to swell, but rice flour bread without gluten or thickener does not have such a gluten network. However, it has been found from the test results in this example that it is possible to produce rice flour bread having good swelling by following a specific production method without gluten and thickener.

### Example 2

The target rice flour bread was obtained and the specific volume of the rice flour bread was measured in the same manner as in Example 1 except that when 250 g of cold rice flour and 220 g of cold water was put in the bread case, 6 g of dry yeast was also added to the bread case, the addition of 6 g of dry yeast when an alarm for notifying a manual operation from IH home bakery sounded was omitted (i.e., the addition of 6 g of dry yeast was performed at an earlier timing). The specific volume of this rice flour bread was 4.2 mL/g.

1. A method of producing rice flour bread dough without using gluten and thickener, comprising:
a cooling step of cooling rice flour and water to prepare cold rice flour and cold water respectively;
a yeast-containing basic dough preparation step of preparing yeast-containing basic dough by mixing the cold rice flour and the cold water, and then preparing yeast-containing basic dough by adding yeast to the basic dough, or preparing yeast-containing basic dough by mixing the cold rice flour, the cold water and yeast; and
a rice flour bread dough preparation step of preparing rice flour bread dough by kneading the yeast-containing basic dough;

2. The method of producing rice flour bread dough according to claim 1, wherein the cooling step includes cooling the rice flour and the water individually to a temperature within a range from 5° C. to 10° C. inclusive.

3. The method of producing rice flour bread dough according to claim 1, wherein the rice flour bread dough preparation step includes preparing the rice flour bread dough by kneading the yeast-containing basic dough while a temperature of the yeast-containing basic dough is being adjusting.

4. The method of producing rice flour bread dough according to claim 1, wherein
the yeast-containing basic dough preparation step and the rice flour bread dough preparation step are performed by an apparatus including a rotor and a rotary drive source for rotating the rotor,
in the yeast-containing basic dough preparation step, a rotation speed of the rotor is increased stepwisely, and
in the rice flour bread dough preparation step, after the rotor is started to rotate at a rotation speed lower than a rotation speed of the rotor at a final stage of the yeast-containing basic dough preparation step, the rotation speed of the rotor is increased stepwisely.

5. The method of producing rice flour bread dough according to claim 1, wherein the rice flour has a damaged starch ratio within a range from 3% to 5% inclusive and a water absorption ratio within a range from 72% to 80% inclusive.

6. A method of producing fermented dough, comprising:
preparing fermented dough by fermenting rice flour bread dough obtained by the method of producing rice flour bread dough according to claim 1.

7. A method of producing rice flour bread, comprising:
producing rice flour bread by heating fermented dough obtained by the method of producing fermented dough according to claim 6.

8. The method of producing rice flour bread according to claim 7, wherein the rice flour bread is produced by heating the fermented dough to a predetermined temperature within a predetermined time.

9. The method of producing rice flour bread according to claim 7, wherein the fermented dough is contained in a container, and the fermented dough is heated by induction-heating the container.

10. The method of producing rice flour bread dough according to claim 2, wherein the rice flour bread dough preparation step includes preparing the rice flour bread dough by kneading the yeast-containing basic dough while a temperature of the yeast-containing basic dough is being adjusting.

11. The method of producing rice flour bread dough according to claim 2, wherein
the yeast-containing basic dough preparation step and the rice flour bread dough preparation step are performed by an apparatus including a rotor and a rotary drive source for rotating the rotor,
in the yeast-containing basic dough preparation step, a rotation speed of the rotor is increased stepwisely, and
in the rice flour bread dough preparation step, after the rotor is started to rotate at a rotation speed lower than a rotation speed of the rotor at a final stage of the yeast-containing basic dough preparation step, the rotation speed of the rotor is increased stepwisely.

12. The method of producing rice flour bread dough according to claim 3, wherein
the yeast-containing basic dough preparation step and the rice flour bread dough preparation step are performed by an apparatus including a rotor and a rotary drive source for rotating the rotor,
in the yeast-containing basic dough preparation step, a rotation speed of the rotor is increased stepwisely, and
in the rice flour bread dough preparation step, after the rotor is started to rotate at a rotation speed lower than a rotation speed of the rotor at a final stage of the yeast-containing basic dough preparation step, the rotation speed of the rotor is increased stepwisely.

13. The method of producing rice flour bread dough according to claim 2, wherein the rice flour has a damaged starch ratio within a range from 3% to 5% inclusive and a water absorption ratio within a range from 72% to 80% inclusive.

14. The method of producing rice flour bread dough according to claim 3, wherein the rice flour has a damaged starch ratio within a range from 3% to 5% inclusive and a water absorption ratio within a range from 72% to 80% inclusive.

15. The method of producing rice flour bread dough according to claim 4, wherein the rice flour has a damaged starch ratio within a range from 3% to 5% inclusive and a water absorption ratio within a range from 72% to 80% inclusive.

16. A method of producing fermented dough, comprising:
preparing fermented dough by fermenting rice flour bread dough obtained by the method of producing rice flour bread dough according to claim 2.

17. A method of producing fermented dough, comprising:
preparing fermented dough by fermenting rice flour bread dough obtained by the method of producing rice flour bread dough according to claim 3.

18. A method of producing fermented dough, comprising:
preparing fermented dough by fermenting rice flour bread dough obtained by the method of producing rice flour bread dough according to claim 4.

19. A method of producing fermented dough, comprising:
preparing fermented dough by fermenting rice flour bread dough obtained by the method of producing rice flour bread dough according to claim 5.

20. The method of producing rice flour bread according to claim 8, wherein the fermented dough is contained in a container, and the fermented dough is heated by induction-heating the container.
